(19) United States
(12) Patent Application Publication
(10) Pub. No.: US 2007/0299807 A1
(43) Pub. Date: Dec. 27, 2007

(54) Apparatus and method for organizing user's life pattern

(75) Inventors: Jong-ho Lea, Seongnam-si (KR); Soon-joo Kwon, Yongin-si (KR); Sung-bae Cho, Seoul (KR); Hee-seob Ryu, Suwon-si (KR); Yong-beom Lee, Seoul (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD, Suwon-si (KR); INDUSTRY-ACADEMIC COOPERATION FOUNDATION, Suwon-si (KR); YONSEI UNIVERSITY, Seoul (KR)

(21) Appl. No.: 11/806,651

(22) Filed: Jun. 1, 2007

(30) Foreign Application Priority Data
Jun. 2, 2006 (KR) 10-2006-0049906

(51) Int. Cl. G06F 17/30; G06F 19/00

(52) U.S. Cl. 707/1; 701/102

(57) ABSTRACT

An apparatus and method to organize a user's life pattern are provided. The apparatus includes a landmark probability estimating module to estimate statistically at least one landmark based on log data indicating a user's life pattern, an image generation module to generate image corresponding to a landmark included in a group chosen from a plurality of groups including at least one landmark with reference to connections among the estimated landmarks, and an image group creation module to create an image group by arranging the images according to predetermined rules.

### CROSS-REFERENCE TO RELATED APPLICATIONS

This application claims priority from Korean Patent Application No. 10-2006-0049906 filed on Jun. 2, 2006 in the Korean Intellectual Property Office, the disclosure of which is incorporated herein by reference in its entirety.

### BACKGROUND OF THE INVENTION

1. Field of the Invention

The present invention relates to an apparatus and method to organize a user's life pattern, and more particularly, to an apparatus and method to organize a user's life pattern which can summarize a user's experiences with reference to data indicating the user's life pattern and can provide the results of the summarization to the user as multimedia data.

2. Description of the Related Art

With the development of ubiquitous and wired/wireless technologies, users can collect various data regarding their daily lives at any time. Users almost always carry their mobile devices (such as digital cameras and mobile phones) with them and can effectively collect various data regarding making phone calls, taking photos, and playing back music files, and location information.

Users who wish to use their mobile devices as life recorders can be provided with and enjoy a variety of services by effectively using data collected by their mobile devices.

For example, if a person's experiences can be effectively summarized based on log data collected by a mobile device, the results of the summarization may help the person's memory, like a diary, and may be used to enhance the person's interactions with smart devices (e.g., home appliances or smart homes) or with other people. In particular, multimedia data such as images is generally more effective than text data for use in enhancing a person's interactions with devices or with other people and describing a person's personal experiences.

Therefore, it is necessary to develop techniques to summarize a person's life experiences based on data collected by a mobile device of the person and providing the results of the summarization as multimedia data.

### SUMMARY OF THE INVENTION

Additional aspects and/or advantages of the invention will be set forth in part in the description which follows and, in part, will be apparent from the description, or may be learned by practice of the invention.

The present invention provides an apparatus and method to organize a user's life pattern which can summarize a user's experiences with reference to data collected by a mobile device and can provide the results of the summarization to the user as multimedia data.

However, the embodiments of the present invention are not restricted to the one set forth herein. The above and other embodiments of the present invention will become more apparent to one of daily skill in the art to which the present invention pertains by referencing a detailed description of the present invention given below.

According to an aspect of the present invention, there is provided an apparatus to organize a user's life pattern. The apparatus includes a landmark probability reasoning module to estimate statistically at least one landmarks based on log data indicating a user's life pattern, an image generation module which generates a image corresponding to a landmark included in a group chosen from a plurality of groups including at least one landmark with reference to connections among the reasoned landmarks, and an image group creation module which creates an image group by arranging the images according to predetermined rules.

According to another aspect of the present invention, there is provided a method of organizing a user's life pattern. The method includes statistically estimating at least one landmarks based on log data indicating a user's life pattern, generating a images corresponding to a landmark included in a group chosen from a plurality of groups including at least one landmark with reference to connections among the reasoned landmarks, and (c) creating an image group by arranging the images according to predetermined rules.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus to organize a user's life pattern according to an embodiment of the present invention;

FIG. 2 illustrates a geographic information table according to an embodiment of the present invention;

FIG. 3 is a table presenting user profile information according to an embodiment of the present invention;

FIG. 4 is a table presenting panel information according to an embodiment of the present invention;

FIG. 5A illustrates a first panel information mapping table including panel information regarding landmarks according to an embodiment of the present invention;

FIG. 5B illustrates a second panel information mapping table including panel information regarding times and places according to an embodiment of the present invention;

FIG. 6 is a graph presenting results obtained by performing impact analysis on log data generated by the apparatus illustrated in FIG. 1 regarding the playback of a music file according to an embodiment of the present invention;

FIG. 7 is a table presenting log context analyzed by an analysis module illustrated in FIG. 1 according to an embodiment of the present invention;

FIGS. 8A through 8D are diagrams for explaining the reasoning of landmarks according to an embodiment of the present invention;

FIGS. 9A through 9D are diagrams to explain the calculation of the strength of connections between landmarks according to an embodiment of the present invention;

FIG. 10 is a diagram to explain the selection of landmarks to be included in a diary according to an embodiment of the present invention;

FIG. 11 presents XML data describing an image corresponding to landmarks to be included in a diary according to an embodiment of the present invention;

FIG. 12 is a diagram to illustrate a plurality of characters representing various emotions according to an embodiment of the present invention;

FIG. 13 is a diagram to illustrate an image obtained by synthesizing one or more panels according to an embodiment of the present invention;

FIG. 14 is a flowchart illustrating a method of organizing a user's life pattern according to an embodiment of the present invention; and

FIG. 15 is a detailed flowchart illustrating operation S710 of FIG. 14.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

An apparatus to organize a user's life pattern according to an embodiment of the present invention collects data indicating a user's life pattern, and provides a cartoon diary that sums up the user's experiences based on the collected data. In order to determine the user's life pattern, the apparatus to organize a user's life pattern may use a variety of data, for example, data received from an external apparatus, data internally generated by the apparatus to organize a user's life pattern, or data stored in an external storage. In detail, examples of the data used by the apparatus to organize a user's life pattern include data provided by websites such as weather, atmospheric temperature, and wind velocity data, data provided by personal information managers (PIMs) such as age, sex, occupation, hobby, habit, address, and anniversary data, and log data regarding making phone calls, sending/receiving Short Message Service (SMS) messages, taking photos, and playing back music files.

The apparatus to organize a user's life pattern may be realized as a digital apparatus. Here, the digital apparatus is an apparatus equipped with a digital circuit capable of processing digital data. Examples of the digital apparatus include a computer, a digital camera, a digital home appliance, a digital telephone, a digital projector, a home server, a digital video recorder, a digital satellite broadcast receiver, a set-top box, and a digital TV broadcast receiver. It will hereinafter be assumed that the apparatus to organize a user's life pattern is realized as a mobile phone, for example.

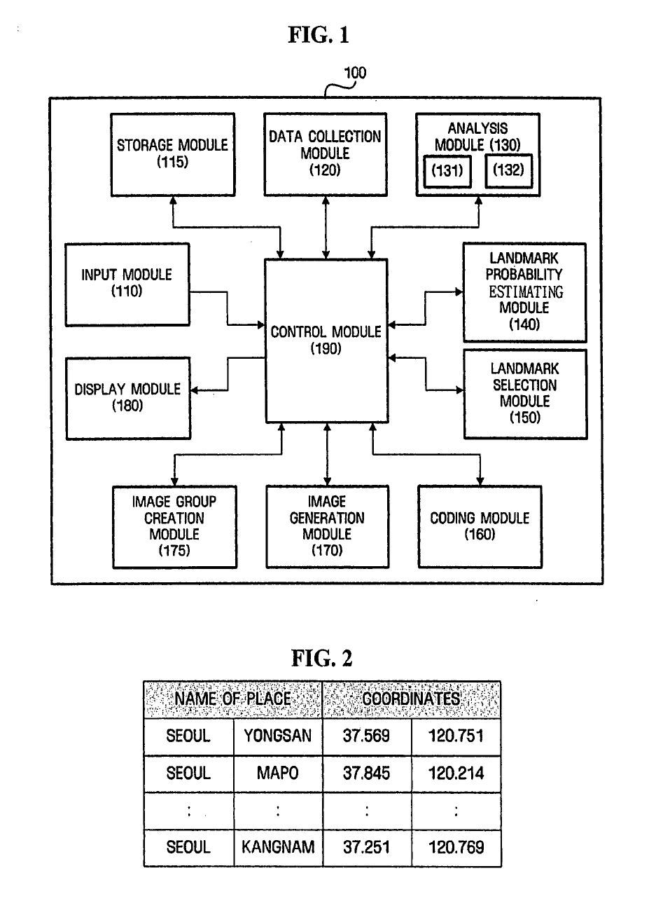

FIG. 1 is a block diagram of an apparatus 100 to organize a user's life pattern according to an embodiment of the present invention. Referring to FIG. 1, the apparatus 100 includes an input module 110, a storage module 115, a data collection module 120, an analysis module 130, a landmark probability estimating module 140, a landmark selection module 150, a coding module 160, an image generation module 170, an image group creation module 175, a display module 180, and a control module 190.

The input module 110 receives a command from a user and may include a plurality of keys, e.g., a power key and a plurality of letter keys. Each of the keys included in the input module 110 generates a key signal when being hit by the user.

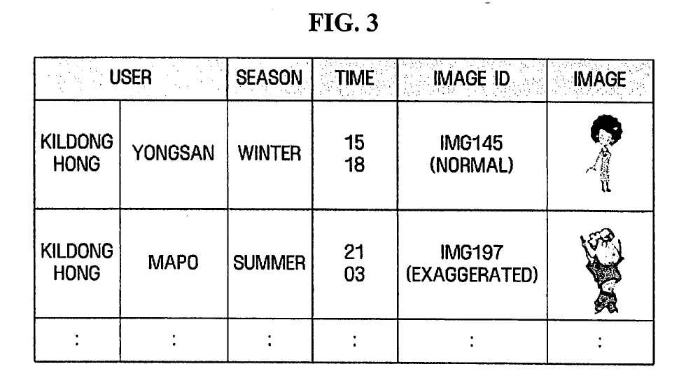

The storage module 115 stores a geographic information table which is illustrated in FIG. 2 and presents the correspondence between a plurality of coordinate values and the names of places, user profile information which includes information regarding the types of characters preferred by the user and is illustrated in FIG. 3, and a Bayesian network which is realized as a module and is used by the landmark probability estimating module 140 to estimate landmarks associated with the user's actions, emotional states, and the circumstances of the user.

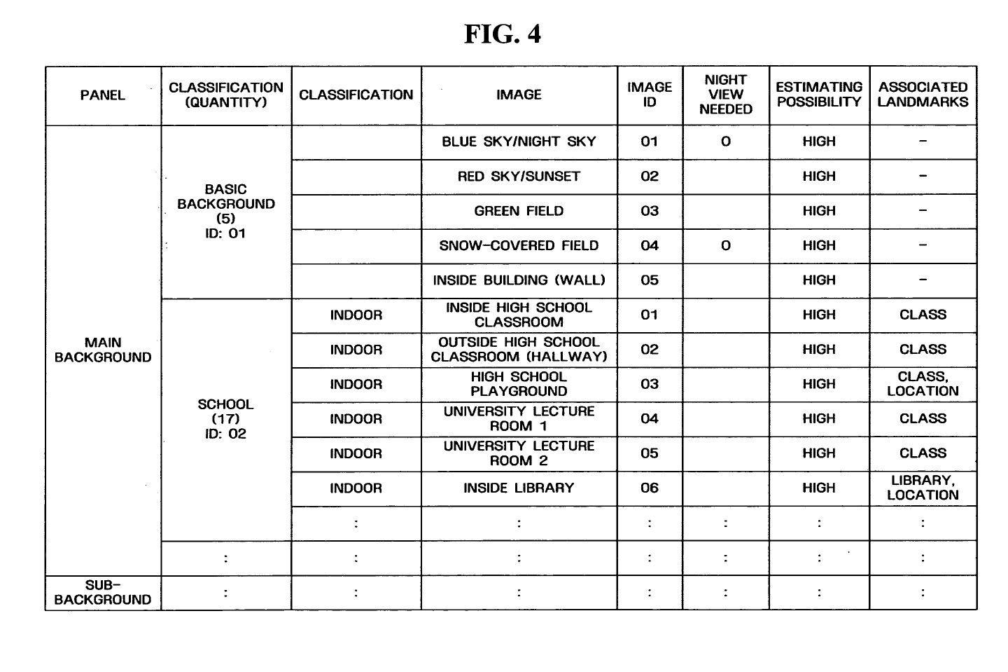

The storage module 115 also stores a plurality of panels needed to create an image corresponding to landmarks to be included in a diary, as illustrated in FIG. 4. The panels may be classified into main characters, sub-characters, main backgrounds, sub-backgrounds, character effects, and comments. An image corresponding to landmarks can be created by synthesizing one or more of the aforementioned panels.

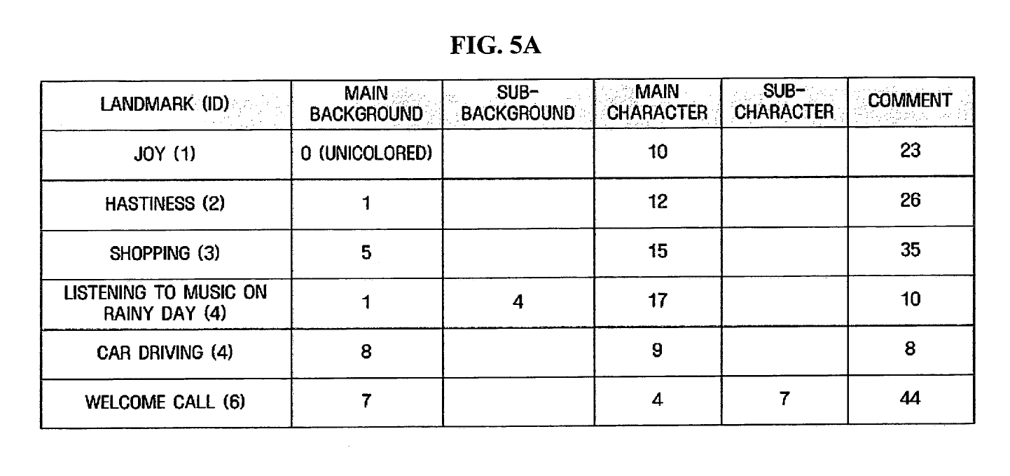

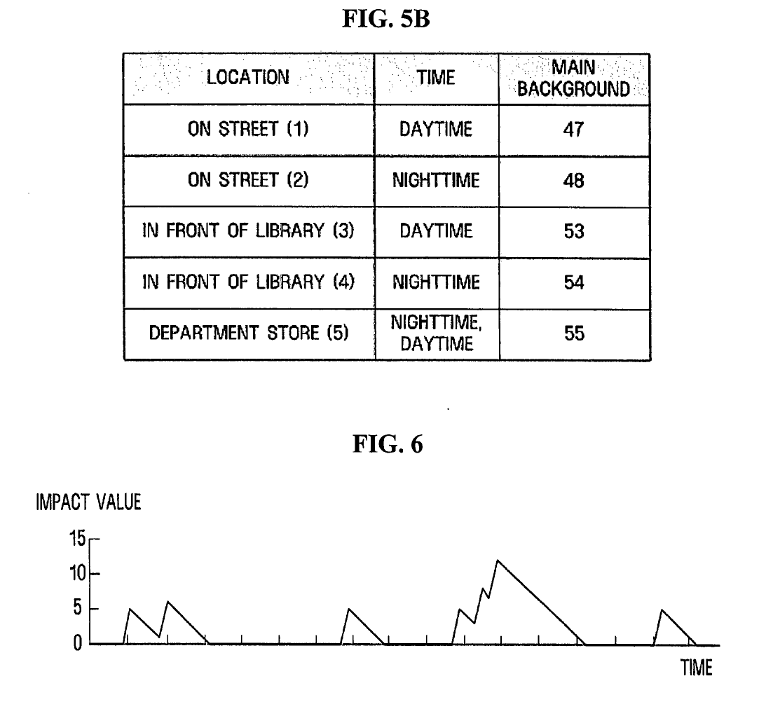

The storage module 115 also stores a first panel information mapping table including panel information regarding landmarks, and a second panel information including panel information regarding times and places. The first panel mapping information and the second panel mapping information will hereinafter be described in detail with reference to FIGS. 5A and 5B, respectively.

FIG. 5A illustrates the first panel information mapping table, and FIG. 5B illustrates the second panel information mapping table. Referring to FIG. 5A, the first panel information mapping table presents the correspondence between landmarks and cartoon images for each panel. For example, a landmark ‘joy’ is mapped to a main background identified by reference numeral 0 (unicolored), has no mapping information regarding sub-background and sub-characters, main character is identified by reference numeral 10, and is mapped to a comment identified by reference numeral 23.

Referring to FIG. 5B, the second panel information mapping table presents the correspondence among location information, time information, and main background image information. For example, the combination of location information ‘streets’ and time information ‘daytime’ is mapped to a main background image identified by reference numeral 47, and the combination of the location information ‘streets’ and time information ‘nighttime’ is mapped to a main background image identified by reference numeral 48. The first and second panel information mapping tables are referenced by the coding module 160 to create an image corresponding to landmarks as a markup document.

The storage module 115 may also store location data and various log data collected by the data collection module 120 and images corresponding to landmarks. The storage module 115 may be realized as a non-volatile memory device such as a read only memory (ROM), a programmable ROM (PROM), an Erasable Programmable ROM (EPROM), an electrically erasable programmable ROM (EEPROM), or a flash memory, may be realized as a volatile memory device such as a random access memory (RAM), or may be realized as a storage medium such as a hard disc drive (HDD). But it is not limited thereto.

The data collection module 120 collects data indicating the user's life pattern. In other words, the data collection module 120 collects data regarding the use of the apparatus 100, for example, log data regarding making phone calls, sending/receiving SMS messages, taking photos, and playing back multimedia content. In detail, when the user transmits a text message, the data collection module 120 collects data regarding, for example, the content of the text message, the recipient of the text message, and the time of transmission of the text message. When the user makes a call, the data collection module 120 collects data regarding, for example, the recipient of the call, the length of the call, and call traffic. When the user plays back a music file (a DMB file, a video file, and etc), the data collection module 120 collects data regarding, for example, the genre and title of the song or music, the name of the singer (the names of actors/actresses in the case of movie files), the number of times the music file has been played back, and the length of the song or music.

The data collection module 120 may also collect location information of the user. For this, the data collection module 120 may include a Global Positioning System (GPS). The GPS receives a coordinate value corresponding to a current location of the user. The data collection module 120 may also collect various data such as weather, atmospheric temperature, wind velocity, and news data from websites.

The analysis module 130 statistically analyzes the data collected by the data collection module 120. For this, the analysis module 130 may include a location information analysis unit 131 and a log data analysis unit 132.

The location information analysis unit 131 analyzes location data provided by the data collection module 120. In detail, when the location information analysis unit 131 is provided with the coordinate value corresponding to the current location of the user by the data collection module 120, the location information analysis unit 131 searches the geographic information table illustrated in FIG. 2 for the name of a place corresponding to the received coordinate value. Also, the location information analysis unit 131 analyzes data indicating how long the user has stayed in a certain place and data indicating the movement speed of the user.

The log data analysis module 132 creates log context by statistically analyzing the log data provided by the data collection module 120. For this, the log data analysis module 132 may use various preprocessing functions, for example, a daily frequency function, a time interval function, an instant impact function, a daily impact function, an event time span function, a daily time portion function, and a daily priority function. The definitions of the daily frequency function, the time interval function, the instant impact function, the daily impact function, the event time span function, the daily time portion function, and the daily priority function are presented in Table 1 below.

TABLE 1

| Function | Definition |
|---|---|
| Daily frequency | Number of times event has occurred during one day |
| Time-interval | Elapse of time after least recent occurrence of event |
| Instant impact | Impact caused by occurrence of event (High/Low) |
| Daily impact | Daily check impact (High/Low) |
| Event time-span | Time span between beginning and ending of event |
| Daily time-portion | Portion of day occupied by event |
| Daily priority | Daily check events with high priorities |

For example, in order to analyze log data regarding the playback of a music file, the log data analysis unit 132 may use the preprocessing functions presented in Table 1 to perform impact analysis, and can thus determine how many times the music file has been played back during one day, how much time has elapsed since the least recent playback of the music file, a time span between the time when the music file begins to be played back and the time when the playback of the music file ends (in other words, for how many hours the music file has been played back), and whether the playback of the music file has been performed intensively within a short period of time. Impact analysis will hereinafter be described in detail with reference to FIG. 6.

FIG. 6 is a graph presenting results obtained by performing impact analysis on log data regarding the playback of a music file. Referring to FIG. 6, when a music file is played back for the first time, a predetermined impact is generated. The predetermined impact gradually disappears over time. If the music file is played back again before the predetermined impact all disappears, an additional impact is generated, and the value of the additional impact is added to a current value of the predetermined impact. For example, if a default impact value is 5 and is decreased by 1 every ten seconds, then when the music file is played back for the first time, an impact having a default value of 5 is generated. The value of the impact is reduced to 3 after twenty seconds the music file is played back for the first time. If the music file is played back again when the value of the impact is 3, an additional impact having a value of 5 is generated, and the additional impact value of 5 is added to the current impact value of 3, thereby obtaining an impact value of 8. Once impact analysis is performed on each log data in the aforementioned manner, it can be determined whether a corresponding event has been performed intensively within a short period of time.

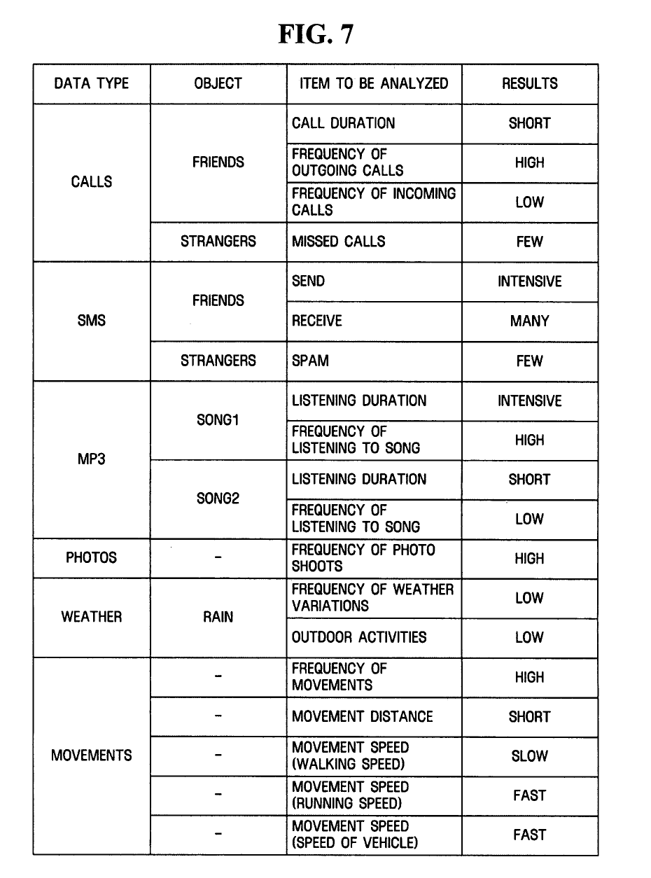

Log context illustrated in FIG. 7 can be obtained by statistically analyzing the log data provided by the data collection module 120 using the preprocessing functions presented in Table 1.

The landmark probability estimating module 140 statistically estimates landmarks based on the results of the analysis performed by the location information analysis unit 131 and the log context provided by the log data analysis module 132. In other words, the landmark probability estimating module 140 estimates landmarks associated with the user's action, emotional state, the circumstances of the user, and an event.

In order to reason landmarks associated with the user's action, emotional state, the circumstances of the user, and an event, the landmark probability reasoning module 140 may use a Bayesian network. A Bayesian network is a graph of nodes and arcs representing the relations among variables included in data. Nodes of a Bayesian network represent random variables, and arcs represent connections among the nodes.

A Bayesian network may be designed as a module in order to efficiently perform computation needed for landmark estimating. In detail, the user's actions may include taking a rest, sleeping, having a meal, studying, exercising, attending school, going home from school, taking classes, enjoying entertainment, having a get-together, taking a trip, climbing a mountain, taking a walk, go shopping, and/or dining out. The user's emotions may be classified into positive emotions such as joy and negative emotions such as anger and irritability. The circumstances of the user may be classified into time circumstances, spatial circumstances, the weather, the state of a device, and the circumstances of people around the user. A Bayesian network may be designed as a module for each of the aforementioned classifications, wherein the Bayesian network may be a hierarchical Bayesian network having a hierarchical structure.

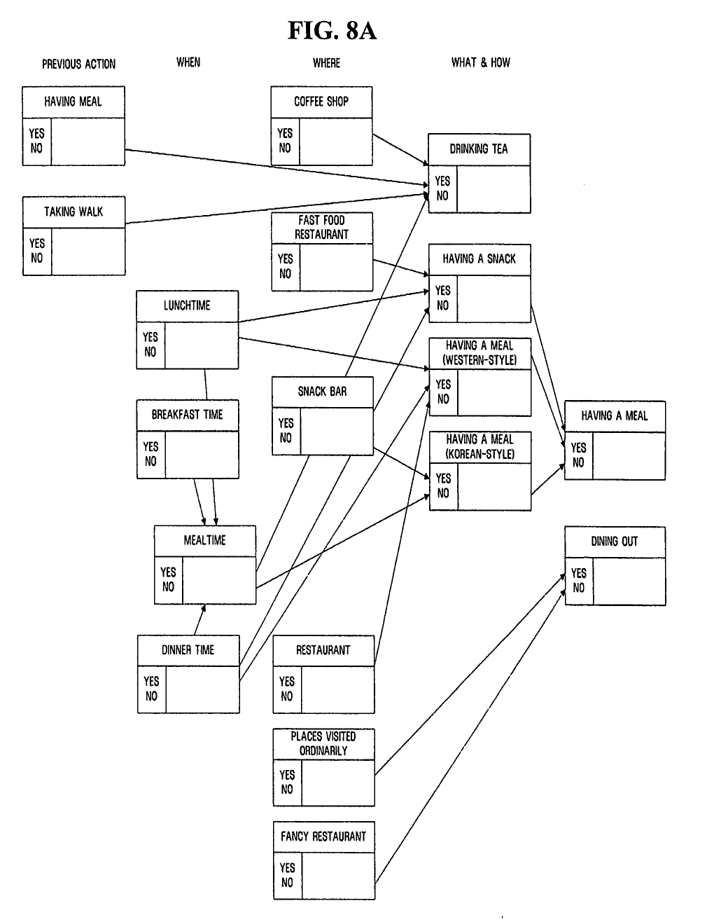

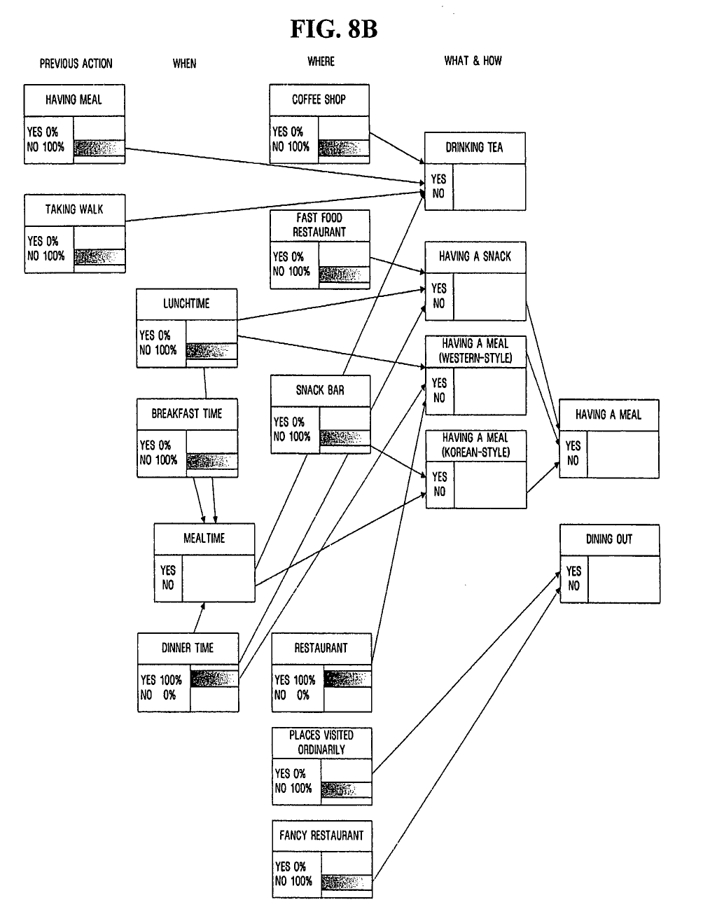

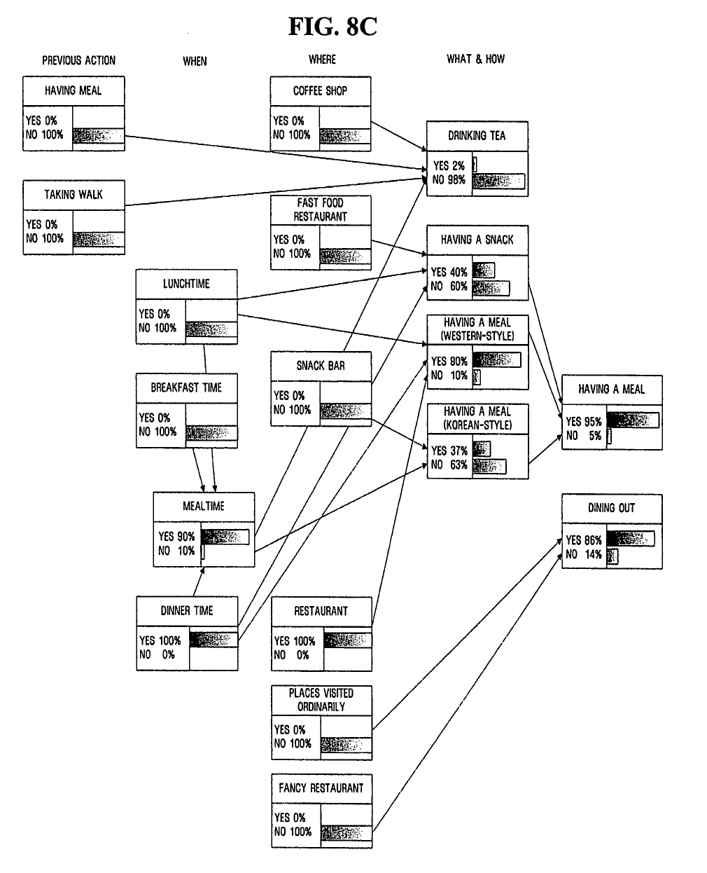

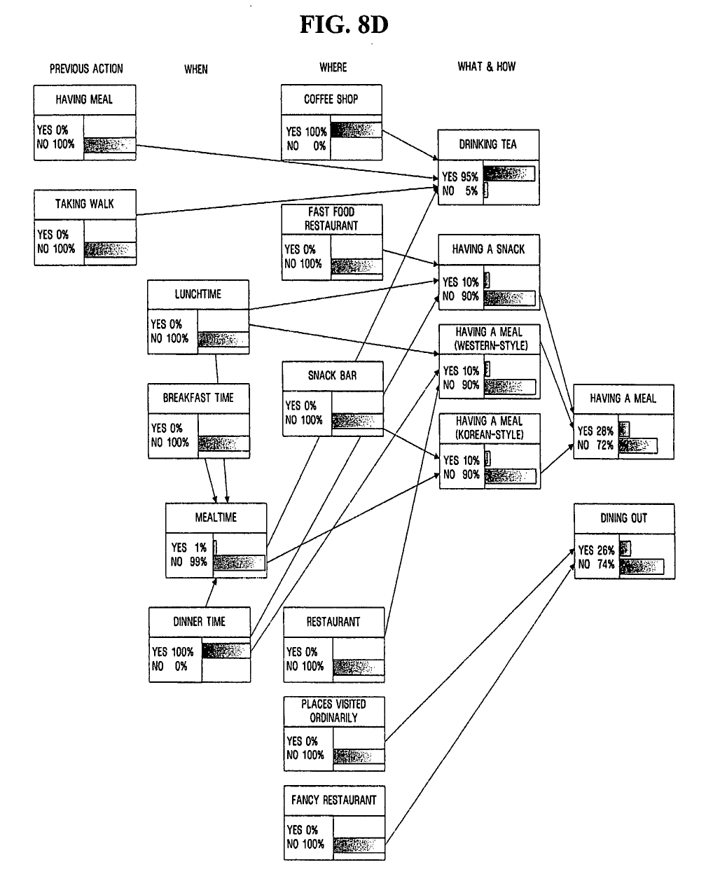

The landmark probability estimating module 140 estimates landmarks using one or more hierarchical Bayesian networks. For this, the landmark probability estimating module 140 inputs log context currently being discovered regarding, for example, photos, music file playback records, call records, SMS records, weather information, current location information, information indicating whether the user is currently on the move, the movement speed of the user, and the user's previous actions, to a Bayesian network, thereby reasoning landmarks. This will hereinafter be described in further detail with reference to FIGS. 8A through 8D.

FIG. 8A is a diagram to illustrate part of a hierarchical Bayesian network for landmark estimating, and particularly, a hierarchical Bayesian network corresponding to an item ‘dining out’ of a plurality of items needed to estimate a user's actions. Referring to FIG. 8A, nodes associated with the user's previous actions, nodes associated with time, nodes associated with the user's whereabouts, and nodes associated with the user's current actions form a hierarchical structure together. The nodes illustrated in FIG. 8A are classified into input nodes and output nodes. Input nodes are nodes that affect specified output nodes, and output nodes are nodes that are each affected by one or more input nodes. Referring to FIG. 8A, the nodes ‘breakfast time’, ‘lunchtime’, and ‘dinner time’ are classified as input nodes, and the nodes ‘mealtime’, ‘drinking tea’, ‘having a snack’, ‘having a meal (western style)’, ‘having a meal (Korean style)’, ‘having a meal’ and ‘dining out’ are classified as output nodes.

Assume that log context currently being discovered is as indicated by Table 2 below.

TABLE 2

| | | |
|---|---|---|
| Current Location | Restaurant | YES |
| | Places visited ordinarily | NO |
| | Fancy Restaurant | NO |
| Current Time | Dinner time | YES |

| | |
|---|---|
| Previous Actions | None |

The landmark probability estimating module 140 inputs as evidence the log context presented in Table 2 to the hierarchical Bayesian network corresponding to the item ‘dining out’, thereby calculating the probabilities of the input nodes of the hierarchical Bayesian network. In other words, referring to FIG. 8B, the landmark probability reasoning module 140 network. In other words, referring to FIG. 8B, the landmark probability estimating module 140 calculates the probabilities of the nodes belonging to categories ‘Previous Actions’, ‘When’, and ‘Where’. In detail, referring to Table 2, there are no previous actions of the user. Thus, the probability that the user has not yet had a meal is 100%, and the probability that the user has not yet taken a walk is 100%. Likewise, referring to Table 2, it is dinner time. Thus, the probability that it is not lunch time is 100%, and the probability that it is not breakfast time is 100%.

Referring to FIG. 8B, once the probabilities of the input nodes of the hierarchical Bayesian network are calculated, the landmark probability estimating module 140 calculates the probabilities of the output nodes of the hierarchical Bayesian network based on the connections among the input nodes of the hierarchical Bayesian network. In detail, referring to FIG. 8C, the landmark probability estimating module 140 calculates the probabilities of the nodes associated with the user's current actions, i.e., the nodes belonging to category ‘What & How’. The probability that the user is having a snack is affected by the probability that the user is in a fast food restaurant, the probability that it is lunch time, and the probability that it is dinner time. Referring to FIG. 8B, the probability that the user is in a fast food restaurant and the probability that it is lunch time are both 0% and the probability that it is dinner time is 100%. Accordingly, the probability that the user is having a snack is 40%, as illustrated in FIG. 8C. The probability that the user is drinking tea is affected by the user's previous actions and the probability that the user is in a coffee shop. Referring to FIG. 8B, the probability that the user has already had a meal and the probability that the user has already taken a walk are both 0%, and the probability that the user is not in a coffee shop is 100%. Accordingly, the probability that the user is drinking tee is 2%, as illustrated in FIG. 8C according to an aspect of the present invention.

Likewise, the landmark probability estimating module 140 calculates the probability that the user is dining out based on the probability that the user is in a place where the user visits ordinarily, the probability that the user is in a fancy restaurant, and the probability that the user is having a meal.

If log context currently being discovered is as indicated by Table 3, results obtained by inputting as evidence the current log context to the hierarchical Bayesian network corresponding to the item ‘dining out’ are illustrated in FIG. 8D.

TABLE 3

| | | |
|---|---|---|
| Current Location | Coffee shop | YES |
| Current Time | Mealtime | NO |

| | |
|---|---|
| Previous Actions | None |

In detail, referring to the hierarchical Bayesian network corresponding to the item ‘dining out’, the probability that the user is drinking tea is affected by the probability that the user has already had a meal, the probability that the user has already taken a walk, the probability that the user is in a coffee shop, and the probability that it is mealtime. Table 3 indicates that the user is currently in a coffee shop and that it is not mealtime. Accordingly, the probability that the user is drinking tea is determined to be 95% based on the evidence input to the hierarchical Bayesian network corresponding to the item ‘dining out’.

Likewise, the probability that the user is having a snack is affected by the probability that the user is in a fast food restaurant, the probability that it is lunch time, and the probability that it is dinner time. Table 3 indicates that the user is currently in a coffee shop and that it is not mealtime. Accordingly, the probability that the user is in a fast food restaurant, the probability that it is lunch time, and the probability that it is dinner time are all 0%. Thus, the probability that the user is having a snack is as low as 10%.

Likewise, the landmark probability estimating module 140 calculates the probability that the user is having Korean food and the probability that the user is having western food. Thereafter, the landmark probability estimating module 140 calculates the probability that the user is dining out based on the probability that the user is having a meal, the probability that the user is in a place where the user visits ordinarily, and the probability that the user is in a fancy restaurant. By referencing the evidence presented in Table 3, the landmark probability estimating module 140 determines the probability that the user is dining out to be 26%.

The landmark probability estimating module 140 inputs log context currently being discovered to a hierarchical Bayesian network corresponding to each item as evidence in the aforementioned manner, thereby estimating landmarks.

Thereafter, the landmark probability estimating module 140 inputs the landmarks and the log context to each Bayesian network as evidence, thereby secondarily estimating landmarks. In this case, the landmark probability estimating module 140 may use a virtual node method to precisely reflect the landmarks to be input as evidence to each Bayesian network. The virtual node method is a method involving the adding of virtual nodes to reflect statistical evidence to a Bayesian network and applying the probability of evidence using the conditional probability values (CPVs) of the virtual nodes. The virtual node method is well taught by E. Horvitz, S. Dumais, P. Koch, “Learning predictive models of memory landmarks,” CogSci 2004: 26th Annual Meeting of the Cognitive Science Society, 2004, which is incorporated herein by reference, and thus, a detailed description thereof will be omitted.

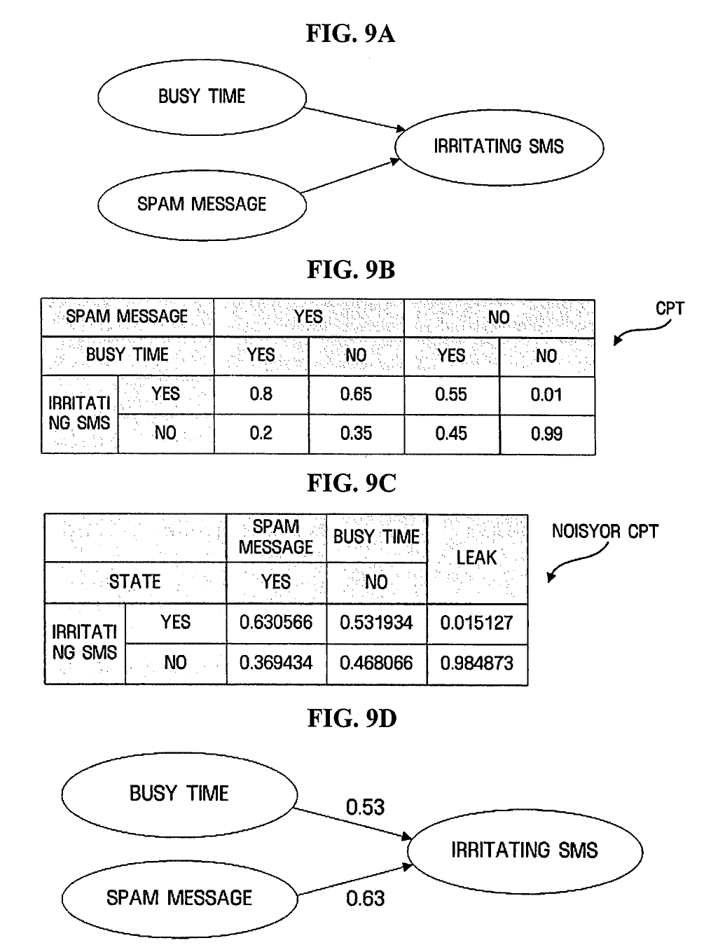

Thereafter, the landmark probability estimating module 140 calculates causal relationships between the landmarks obtained through the secondary estimating operation and the strengths of the connections between the landmarks obtained through the secondary estimating operation. In order to calculate the strengths of the connections between the landmarks obtained through the secondary estimating operation, the landmark probability estimating module 140 may use a NoisyOR weight. A NoisyOR weight represents the strength of a connection between conditional probabilities for each cause used in a NoisyOR Bayesian network model, which is a Bayesian probability table calculation method capable of reducing designing and learning costs. A NoisyOR weight can be obtained by converting an ordinary conditional probability table (CPT) into a NoisyOR CPT, and this will hereinafter be described with reference to FIGS. 9A through 9D.

FIGS. 9A through 9D are diagrams to explain the calculation of the strengths of connections between a plurality of landmarks. In detail, FIG. 9A illustrates causal relationships between a plurality of landmarks ‘busy time’, ‘spam message’, and ‘irritating SMS message’. Referring to FIG. 9A, the landmarks ‘busy time’ and ‘spam message’ cause the landmark ‘irritating SMS message’. An ordinary CPT illustrated in FIG. 9B can be created based on the causal relationships between the landmarks ‘busy time’ and ‘spam message’ and the landmark ‘irritating SMS message’. Referring to the ordinary CPT illustrated in FIG. 9B, when a spam message is received during a busy time of a day, the probability that the received spam message is an irritating SMS message is 0.8. On the other hand, when a spam message is received, but not during a busy time of a day, the probability that the received spam message is an irritating SMS message is 0.65.

The ordinary CPT illustrated in FIG. 9B can be converted into a NoisyOR CPT illustrated in FIG. 9C. Referring to the NoisyOR CPT illustrated in FIG. 9C, the probability that a spam message is an irritating SMS message is 0.630566, and the probability that a message received during a busy time of a day is an irritating SMS message is 0.531934. Afield ‘Leak’ of the NoisyOR CPT illustrated in FIG. 9C presents probabilities that none of the causes of the landmark ‘irritating SMS message’ will occur.

Referring to FIG. 9D, the strengths of the connections between the landmarks ‘busy time’ and ‘spam message’ and the landmark ‘irritating SMS message’ can be determined using the NoisyOR CPT illustrated in FIG. 9C.

Once the strengths of the connections between the landmarks ‘busy time’ and ‘spam message’ and the landmark ‘irritating SMS message’ are determined in the aforementioned manner, the landmark probability estimating module 140 extracts a meaningful connection path by referencing the strengths of the connections between the landmarks ‘busy time’ and ‘spam message’ and the landmark ‘irritating SMS message’. In other words, if the strength of a connection between a pair of nodes is less than a predefined threshold, the landmark probability estimating module 140 deems the connection between the nodes less meaningful, and removes the nodes from a corresponding Bayesian network. For example, referring to FIG. 9D, if the predefined threshold is 0.6, the landmark probability estimating module 140 determines the connection between the landmark ‘busy time’ and the landmark ‘irritating SMS message’ to be less meaningful because the strength of the connection between the landmark ‘busy time’ and the landmark ‘irritating SMS message’ is 0.53. Accordingly, the landmark probability estimating module 140 removes a node corresponding to the landmark ‘busy time’ from a corresponding Bayesian network. On the other hand, since the strength of the connection between the landmark ‘spam message’ and the landmark ‘irritating SMS message’ is 0.63, the landmark probability estimating module 140 does not remove but leaves a node corresponding to the landmark ‘spam message’.

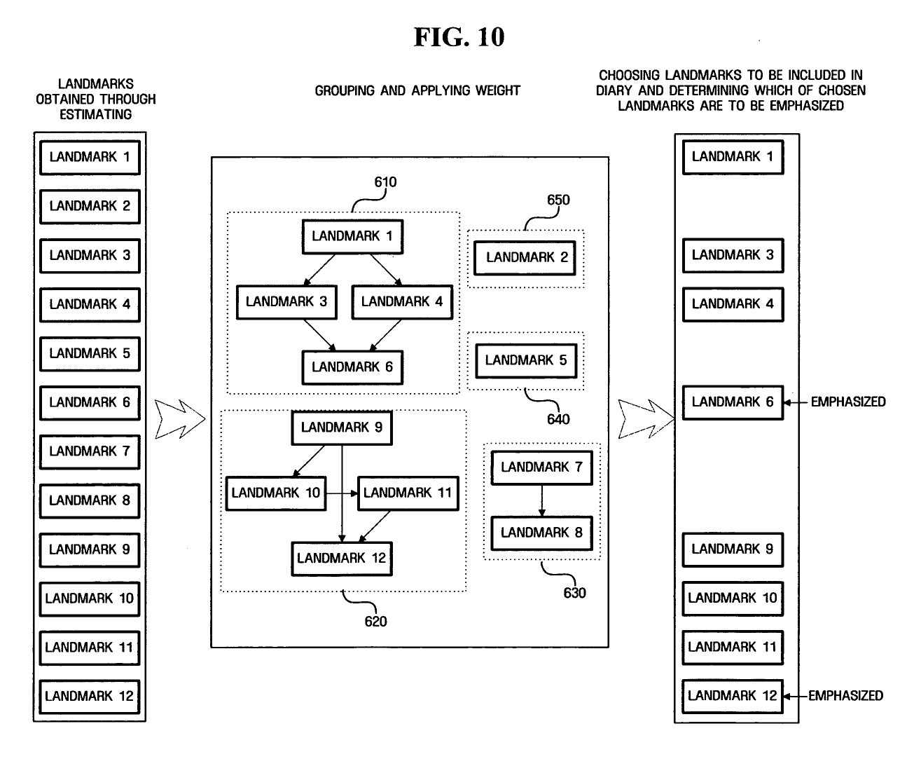

The landmark selection module 150 selects one or more landmarks to be included in a diary from the landmarks obtained by the landmark probability estimating module 140, and determines which of the selected landmarks are to be emphasized. The selection of landmarks will hereinafter be described in further detail with reference to FIG. 10.

FIG. 10 is a diagram to explain the selection of landmarks to be included in a diary and the selection of those of the selected landmarks to be emphasized in the diary. Referring to FIG. 10, if there are a considerable number of landmarks provided through reasoning by the landmark probability estimating module 140, the landmark selection module 150 determines which of the landmarks are to be included in a diary. For this, the landmark selection module 150 classifies the landmarks into one or more groups in consideration of the connections among the landmarks. Referring to FIG. 10, twelve landmarks are classified into five groups, i.e., first through fifth groups 610 through 650 in consideration of the connections among the twelve landmarks. Thereafter, the landmark selection module 150 applies a weight to each of the twelve landmarks. The weight may be determined according to a priority probability value of each of the twelve landmarks. Thereafter, the landmark selection module 150 adds up the weight applied to each of the landmarks included in each of the first through fifth groups 610 through 650, and chooses one of the first through fifth groups 610 through 650 with a highest weighted sum of landmarks, thereby determining which of the twelve landmarks are to be included in a diary. For example, if the weight applied to each of the twelve landmarks is 1, the weighted sum of the landmarks included in the first group 610 is 4, the weighted sum of the landmarks included in the second group 620 is 4, the weighted sum of the landmarks included in the third group 630 is 3, the weighted sum of the landmark included in the fourth group 640 is 1, and the weighted sum of the landmark included in the fifth group 650 is 1. Since the weighted sum of the landmark included in the first group 610 is the same as the applied to the landmarks included in the second group 620, the landmark selection module 150 selects both the landmarks included in the first group 610 and the landmarks included in the second group 620 as landmarks to be included in a diary.

Thereafter, the landmark selection module 150 determines which of the selected landmarks are to be emphasized. For example, the landmark selection module 150 may select one or more landmarks corresponding to a climax from the landmarks included in the first and second groups 610 and 620 as landmarks to be emphasized. In other words, as illustrated in FIG. 10, the landmark selection module 150 may select one or more landmarks corresponding to an end of a connection path formed by the landmarks included in each of the first and second groups 610 and 620 as the landmarks to be emphasized. Alternatively, the landmark selection module 150 may determine landmarks having a probability value higher than a predetermined threshold as the landmarks to be emphasized. For example, assume for a landmark ‘in a hurry’ that, under the general circumstances, the walking speed of a user is 6-7 km per hour. If the walking speed of the user is more than 8 km per hour or higher, the landmark ‘in a hurry’ may be chosen as a landmark to be emphasized.

According to an aspect of the present embodiment, various story lines can be obtained from the landmarks selected by the landmark selection module 150. For example, referring to FIG. 10, a sub-story line comprised of the first, third, and sixth landmarks and a sub-story line comprised of the first, fourth, and sixth landmarks can be obtained from the first group 610. Also, a sub-story line comprised of the ninth, tenth, eleventh, and twelfth landmarks and a sub-story line comprised of the ninth and twelfth landmarks can be obtained from the second group 620. Also, various main story lines can be obtained by appropriately combining the sub-story lines obtained from the first and second groups 610 and 620.

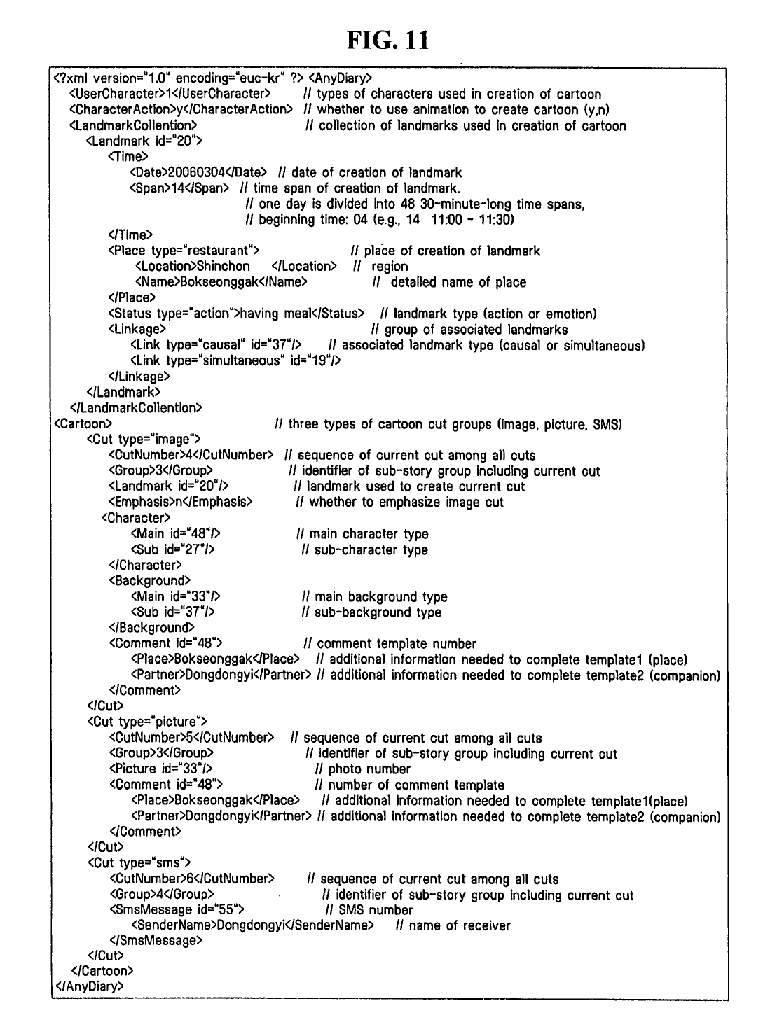

The coding module 160 describes one or more images corresponding to the landmarks to be included in a diary using a markup language such as eXtensible Markup Language (XML) with reference to the user profile information and the panel information mapping tables stored in the storage module 115. FIG. 11 presents an example of an XML image description provided by the coding module 160. Specifically, FIG. 11 presents an XML description of one or more images included in one of a plurality of sub-story lines of a predetermined main story line. The XML image description presented in FIG. 11 specifies the types of images included in a sub-story line identified by reference numeral 3, the order of the images, and panel information of each of the images. Also, the XML image description presented in FIG. 11 indicates that each of the images can be generated with reference to not only panel information but also photos taken by the user or SMS messages.

The image generation module 170 extracts one or more panels from the storage module 115 with reference to the XML image description provided by the coding module 160, and synthesizes the extracted panels, thereby creating an image. For example, if the XML image description provided by the coding module 160 is as illustrated in FIG. 11, the image generation module 170 synthesizes a main character panel identified by reference numeral 48, a sub-character panel identified by reference numeral 27, a main background panel identified by reference numeral 33, a sub-background panel identified by reference numeral 37, and a comment identified by reference numeral 48. The image generation module 170 may synthesize the extracted panels by referencing information regarding the locations of characters in a background image, the viewing directions of the characters, and the arrangement of the characters.

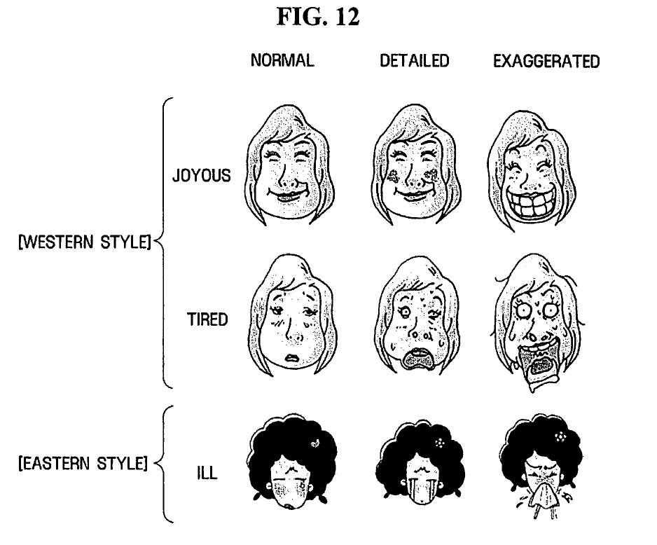

One or more panels associated with an emphasis effect may be chosen for landmarks to be emphasized, and the extracted panels may be synthesized. This will hereinafter be described in further detail with reference to FIG. 12. FIG. 12 illustrates a plurality of characters representing various emotions. Referring to FIG. 12, the characters are classified into normal characters, detailed characters, and exaggerated characters. For example, if a landmark ‘joy’ is one of the landmarks to be emphasized and has a probability value higher than a predetermined threshold, the image generation module 170 may choose an exaggerated main character, rather than a normal main character, for the landmark ‘joy’, and synthesize the chosen main character with other panels.

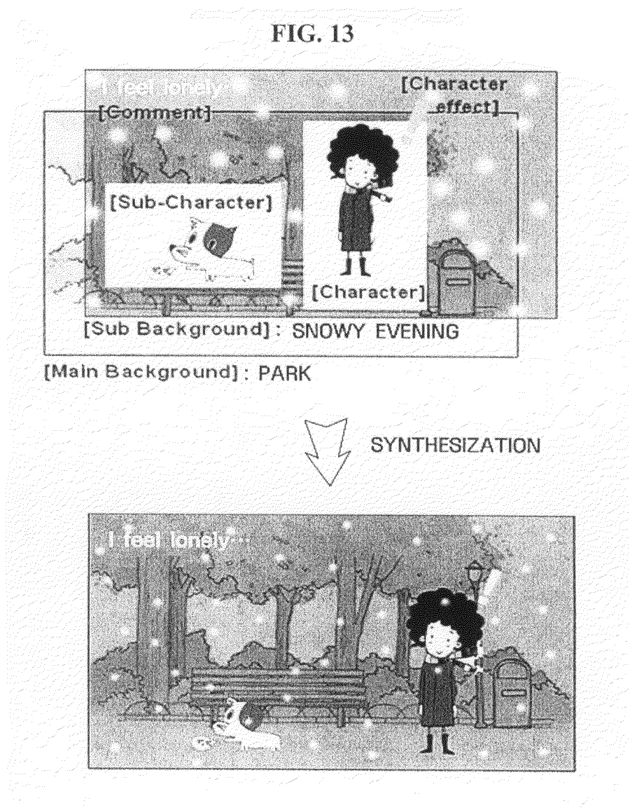

An image illustrated in FIG. 13 can be obtained by synthesizing the panels chosen in the aforementioned manner by the image generation module 170.

The image group creation module 175 arranges one or more images generated by the image generation module 170 according to predetermined rules, thereby creating a diary. The predetermined rules may include at least any one of a time rule, a space rule, and a correlation rule. For example, when using the correlation rule, the image group creation module 175 may arrange the images generated by the image generation module 170 on the basis of a place associated with a landmark. In other words, the image group creation module 175 may arrange only the images associated with a predetermined place according to a predetermined time order, thereby generating an image group.

The display module 180 visually displays results of executing a command input by the user. For example, the display module 180 may display an image generated by the image generation module 170. The display module 180 may be realized as a flat panel display device such as a liquid crystal display (LCD) device. However, it is not limited thereto.

The control module 190 connects and controls the input module 110, storage module 115, data collection module 120, analysis module 130, landmark probability estimating module 140, landmark selection module 150, coding module 160, image generation module 170, the image group creation module 175, and the display module 180 in response to a key signal provided by the input module 110.

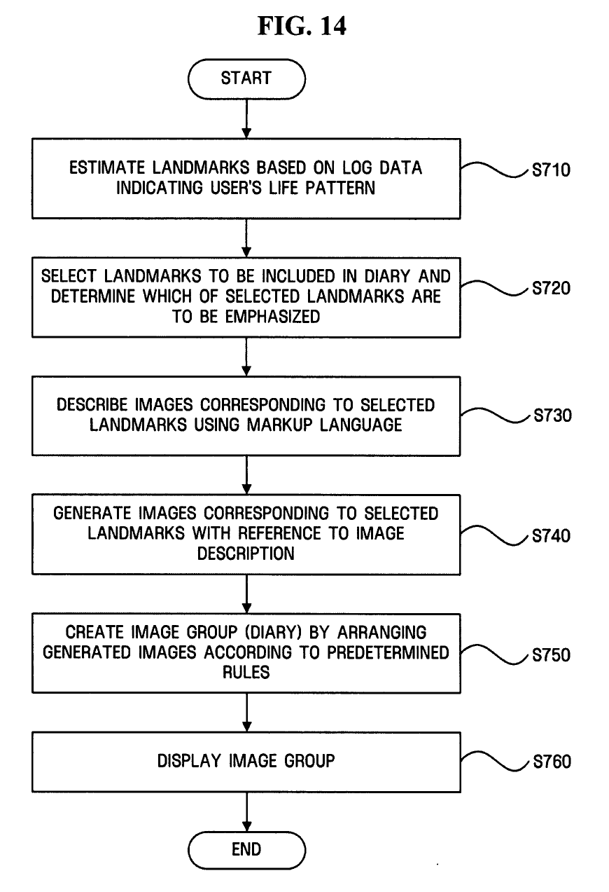

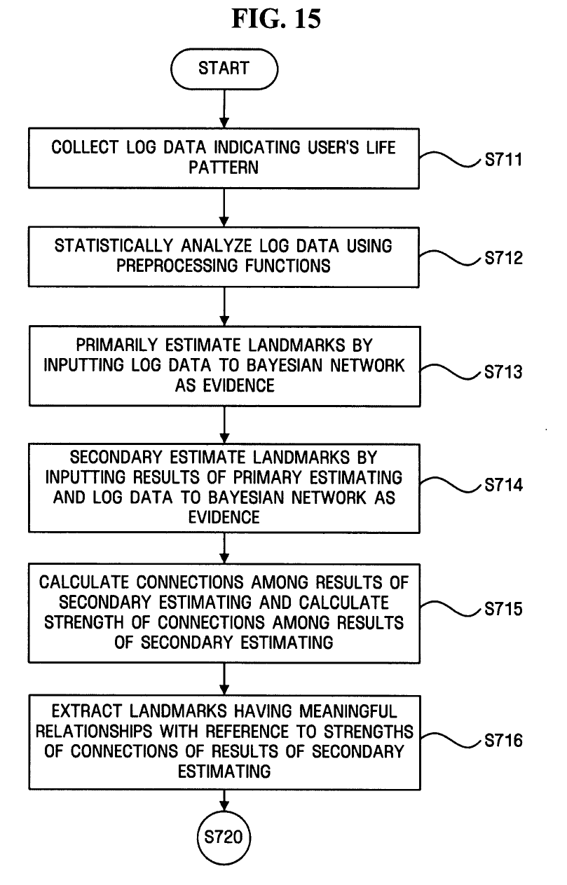

FIG. 14 is a flowchart illustrating a method of organizing a user's life pattern according to an embodiment of the present invention. The apparatus 100 illustrated in FIG. 1 estimates landmarks based on log data indicating a user's life pattern, and this will hereinafter be described in further detail with reference to FIG. 15.

FIG. 15 is a detailed flowchart illustrating operation S710 of FIG. 14. Referring to FIG. 15, in operation S711, the data collection module 120 collects log data indicating a user's life pattern, for example, location information, call records, SMS records, music file playback records, and data collected from websites such as weather and news data.

In operation S712, the analysis module 130 statistically analyzes the log data collected by the data collection module 120 using various preprocessing functions. For example, the analysis module 130 may analyze log data regarding the playback of a music file, thereby determining how many times the music file has been played back during one day, for how long the music file has been played back at a time, and for how many hours the music file has been played back during one day.

Log context is generated as a result of the analysis performed by the analysis module 130. In operation S713, the landmark probability estimating module 140 performs a primary landmark estimating operation by inputting the log context to each Bayesian network. For example, if the log context presented in Table 1 is input to the Bayesian network illustrated in FIG. 8A, i.e., the Bayesian network corresponding to the item ‘dining out’, the landmarks ‘mealtime’, ‘having a meal (western-style)’, ‘having a meal (Korean-style)’, ‘having a meal’, and ‘dining out’ illustrated in FIG. 8C can be obtained as the results of the primary landmark estimating operation, i.e., primary landmarks.

In operation S714, the landmark probability estimating module 140 performs a secondary landmark estimating operation by inputting the primary landmarks and the log context to each Bayesian network.

In operation S715, the landmark probability estimating module 140 determines the connections among a plurality of secondary landmarks obtained as the results of the secondary landmark estimating operation and calculates the strengths of the connections among the secondary landmarks. In order to calculate the strengths of the connections among the secondary landmarks, the landmark probability estimating module 140 may convert a CPT created based on the connections among the secondary landmarks into a NoisyOR CPT.

In operation S716, once the strengths of the connections among the secondary landmarks are determined based on the NoisyOR CPT, the landmark probability estimating module 140 extracts one or more landmarks that are meaningful from the secondary landmarks by referencing the strengths of the connections among the secondary landmarks. In other words, the landmark probability estimating module 140 selects those of the secondary landmarks corresponding to a connection strength greater than a predetermined threshold.

Referring to FIG. 14, in operation S720, the landmark selection module 150 determines which of the landmarks extracted in operation S716 are to be included in a diary. For this, the landmark selection module 150 classifies the extracted landmarks into one or more groups according to the connections among the extracted landmarks. Thereafter, the landmark selection module 150 applies a weight to each of the extracted landmarks, chooses one of the groups with a highest weighted sum of landmarks, and determines the landmarks included in the chosen group as landmarks to be included in a diary. Thereafter, the landmark selection module 150 determines which of the landmarks to be included in a diary are to be emphasized. For example, the landmark selection module 150 may choose a landmark corresponding to an end of a connection path formed by the landmarks included in the chosen group.

In operation S730, the coding module 160 describes one or more images corresponding to the landmarks to be included in a diary, including the landmarks to be emphasized, using a markup language with reference to user profile information and panel information mapping tables. As a result, the coding module 160 may provide the XML image description presented in FIG. 11.

In operation S740, the image generation module 170 extracts one or more panels needed to create images from the storage module 115 with reference to the XML image description provided by the coding module 160, and synthesizes the extracted panels, thereby creating one or more images corresponding to the landmarks to be included in a diary. In this case, the image generation module 170 may choose a panel appropriate for each of the landmarks to be emphasized, and synthesizes the chosen panel with other panels. The image generation module 170 may provide the image illustrated in FIG. 13 as a result of the synthesization performed in operation S740. The images generated by the image generation module 170 may be displayed by the display module 180 and/or may be stored in the storage module 115.

In operation S750, the image group creation module 175 creates an image group, i.e., a diary, by arranging the images generated by the image generation module 170 according to predetermined rules. The image group generated by the image group creation module 175 is displayed by the display module 180 in response to a command input to the input module 110 by the user.

As described above, the apparatus and method to organize a user's life pattern according to an embodiment of the present invention can summarize a user's life pattern into a small number of extraordinary events, systematically combine the results of the summarization using a small number of images, and visualize the result of the combination. Thus, the apparatus and method to organize a user's life pattern according to the present invention can help the user's memory, and satisfy the demand for emotion/life pattern-based estimating.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to organize a user's life pattern comprising:
a landmark probability estimating module to estimate statistically at least one landmark based on log data indicating a user's life pattern;
an image generation module to generate a image corresponding to a landmark included in a group chosen from a plurality of groups including at least one landmark with reference to connections among the estimated landmarks; and
an image group creation module to create an image group by arranging the image according to at least one predetermined rule.

2. The apparatus of claim 1 further comprising a landmark selection module to classify the estimated landmarks into one or more group with reference to connections among the estimated landmarks, each group comprising at least one landmark.

3. The apparatus of claim 2, wherein the landmark selection module applies a weight to each of the landmarks included in each of the groups, and chooses one of the groups with reference to the weighted sum of the landmarks included in each of the groups.

4. The apparatus of claim 3, wherein the landmark selection module determines which of the landmarks included in the chosen group are to be emphasized.

5. The apparatus of claim 1, wherein the image comprise at least any one of a main character panel, a sub-character panel, a main background panel, a sub-background panel, a comment panel, and a character effect panel.

6. The apparatus of claim 1, wherein the image is generated using a markup language.

7. The apparatus of claim 1, wherein the image group creation module to create the image group by connecting the image using a story line.

8. The apparatus of claim 7, wherein the story line is created based on the connections among the landmarks included in the chosen group.

9. The apparatus of claim 1, wherein the at least one predetermined rule comprises any one of a time rule, a space rule, and a correlation rule or combinations thereof.

10. The apparatus of claim 1, further comprising a display module to display the image group.

11. The apparatus of claim 1, further comprising an input module to receive a command.

12. The apparatus of claim 1, further comprising a storage module to store a geographic information table.

13. The apparatus of claim 12, wherein the storage module stores a plurality of panels.

14. The apparatus of claim 1, further comprising a data collection module to collect data indicating the user's life pattern.

15. The apparatus of claim 14, the apparatus further comprising an analysis module to analysis a data collected by the data collection module.

16. The apparatus of claim 15, wherein the analysis module comprises a location information analysis unit to search a geographic information table and/or analyze data indicating how long the user being stayed in a certain place.

17. The apparatus of claim 15, wherein the analysis module comprises a log data analysis module to create log context.

18. The apparatus of claim 1, further comprising a coding module to describe at least one image corresponding to the landmarks.

19. The apparatus of claim 1, wherein the log data is at least any one of making phone calls, sending/receiving Short Message Service (SMS) messages, taking photos, and playing back music files or combinations thereof.

20. A method of organizing a user's life pattern comprising:
statistically estimating at least one landmark based on log data indicating a user's life pattern;
generating a image corresponding to a landmark included in a group chosen from a plurality of groups including at least one landmark with reference to connections among the estimated landmarks; and
creating an image group by arranging the image according to at least one predetermined rule.

21. The method of claim 20 further comprising classifying the estimated landmarks into one or more group with reference to connections among the estimated landmarks, each group comprising at least one landmark.

22. The method of claim 21, wherein the classifying the estimated landmarks comprises applying a weight to each of the landmarks included in each of the groups, and choosing one of the groups with reference to the weighted sum of the landmarks included in each of the groups.

23. The method of claim 22, wherein the applying a weight comprises determining which of the landmarks included in the chosen group are to be emphasized.

24. The method of claim 20, wherein the image comprise at least any one of a main character panel, a sub-character panel, a main background panel, a sub-background panel, a comment panel, and a character effect panel or combinations thereof.

25. The method of claim 20, wherein the image is generated using a markup language.

26. The method of claim 20, wherein the creating an image group comprises creating the image group by connecting the image using a story line.

27. The method of claim 26, wherein the story line is created based on the connections among the landmarks included in the chosen group.

28. The method of claim 20, wherein the at least predetermined rule comprises any one of a time rule, a space rule, and a correlation rule or combinations thereof.

29. The method of claim 20 further comprising displaying the image group.
